(19) United States
(12) Patent Application Publication
(10) Pub. No.: US 2014/0187319 A1
(43) Pub. Date: Jul. 3, 2014

(54) GAME APPARATUS AND BOARD DEVICE THEREOF

(71) Applicant: OZAKI INTERNATIONAL CO., LTD., New Taipei City (TW)

(72) Inventors: Keng-Yuan LIU, New Taipei City (TW); Yun-Jen LIU, New Taipei City (TW)

(73) Assignee: OZAKI INTERNATIONAL CO., LTD., New Taipei City (TW)

(21) Appl. No.: 14/063,226

(22) Filed: Oct. 25, 2013

(30) Foreign Application Priority Data
Dec. 28, 2012 (TW) 101225537

(51) Int. Cl. A63F 13/00

(52) U.S. Cl. CPC A63F 13/00
USPC 463/31

(57) ABSTRACT

A gaming apparatus includes an electric device and a board device. The electric device has a screen. The board device includes a board body. The board body is formed as a plate and includes a board surface and a bottom surface opposite to the board surface. The bottom surface is recessed inward so as to form a hollow. The board surface has an upper opening, and the bottom portion of hollow has a lower opening. The upper opening communicates with the lower opening so as to form a window. The hollow is arranged to receive the electric device, and at least one part of the screen are revealed through the window.

### CROSS-REFERENCES TO RELATED APPLICATIONS

This non-provisional application claims priority under 35 U.S.C. §119(a) on Patent Application No. 101225537 filed in Taiwan, R.O.C. on 2012 Dec. 28, the entire contents of which are hereby incorporated by reference.

### BACKGROUND OF THE INVENTION

1. Technical Field

The present invention relates to an entertainment device, and more particularly to a game apparatus and board device thereof.

2. Related Art

Since ancient times, board games have been one of the most popular leisure activities. To date, numerous board games with different rules and items are created all over the world, such as Chinese chess, Chinese checkers, chess, Japanese chess, etc. However, all the board games mentioned above are applied via a planar plate with directing lines and blocks illustrated thereon according to the game rules. Therefore, multiple players (two players, three players, etc.) place and operate the board pieces on the board surface according to the game rules of the board games.

Unfortunately, due to the development of digital technologies, most people like to play video games, which have powerful audio and visual effects. Consequently, in comparison with video games, the board games mentioned above seem to be more boring. Additionally, people who are familiar with or particularly skilled in the board games mentioned above can win, the board games easily; namely, a rookie player cannot get self-actualization from the board games easily because such players hardly ever win.

### SUMMARY

In view of this, the present invention proposes a board device and a gaming apparatus to solve the problems in the prior arts.

In an embodiment of the present invention, a board device incorporated with an electric device having a screen includes a board body. The board body is formed as a plate and includes a board surface and a bottom surface opposite to the board surface. The bottom surface is recessed so as to form a hollow. The board surface has an upper opening, and a bottom portion of the hollow has a lower opening. The upper opening communicates with the lower opening so as to form a window. The hollow is configured to receive the electric device, and at least one part of the screen is revealed through the window.

In an embodiment of the present invention, a gaming apparatus includes an electric device and a board device. The electric device has a screen. The board device includes a board body. The board body is formed as a plate and includes a board surface and a bottom surface opposite to the board surface. The bottom surface is recessed so as to form a hollow. The board surface has an upper opening, and the bottom portion of the hollow has a lower opening. The upper opening communicates with the lower opening so as to form a window. The hollow is arranged to receive the electric device, and at least one part of the screen is revealed through the window.

According to the board device and the gaming apparatus of the present invention, the placing regions of the board pieces on the electric board surface displayed on the electric device can be sensed so as to trigger various random events during game play, so that the board game can he more interesting.

The detailed features and advantages of the present invention are described below in great detail through the following embodiments, the content of the detailed description of which is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus not limitative of the present invention, wherein:

FIG. 1 is an exploded view of a gaming apparatus of a first embodiment of the present invention;

FIG. 2 is a top view of the board device of the first embodiment of the present invention;

FIG. 3 is a bottom view of the board device of the first embodiment of the present invention;

FIG. 4 is a cross-sectional view of FIG. 3 along line 3-3;

FIG. 5 is an enlarged view of the B circle shown in FIG. 4;

FIG. 6 is a top view of the gaming apparatus of the first embodiment of the present invention;

FIG. 7 is a perspective view of the gaming apparatus of the first embodiment of the present invention;

FIG. 8 is a schematic block view of an electric device of the first embodiment of the present invention;

FIG. 9 is a schematic block view of the board device of the first embodiment of the present invention;

FIG. 10 is a top view of a board device of a second embodiment of the present invention;

FIG. 11 is a schematic view for showing an electric board surface of the second embodiment of the present invention;

FIG. 12 is a schematic view for showing one interactive information of the second embodiment of the present invention;

FIG. 13 is a schematic view for showing another interactive information of the second embodiment of the present invention;

FIG. 14 is a top view of a board device of a third embodiment of the present invention;

FIG. 15 is a top view of a board device of a fourth embodiment of the present invention;

FIG. 16 is a top view of a board device of a fifth embodiment of the present invention;

FIG. 17 is a top view of a board device of a sixth embodiment of the present invention;

FIG. 18 is a perspective view of a board device of a seventh embodiment of the present invention;

FIG. 19 is an exploded view of a board device of an eighth embodiment of the present invention; and

FIG. 20 is a front view of the board device of an eighth embodiment of the present invention.

### DETAILED DESCRIPTION

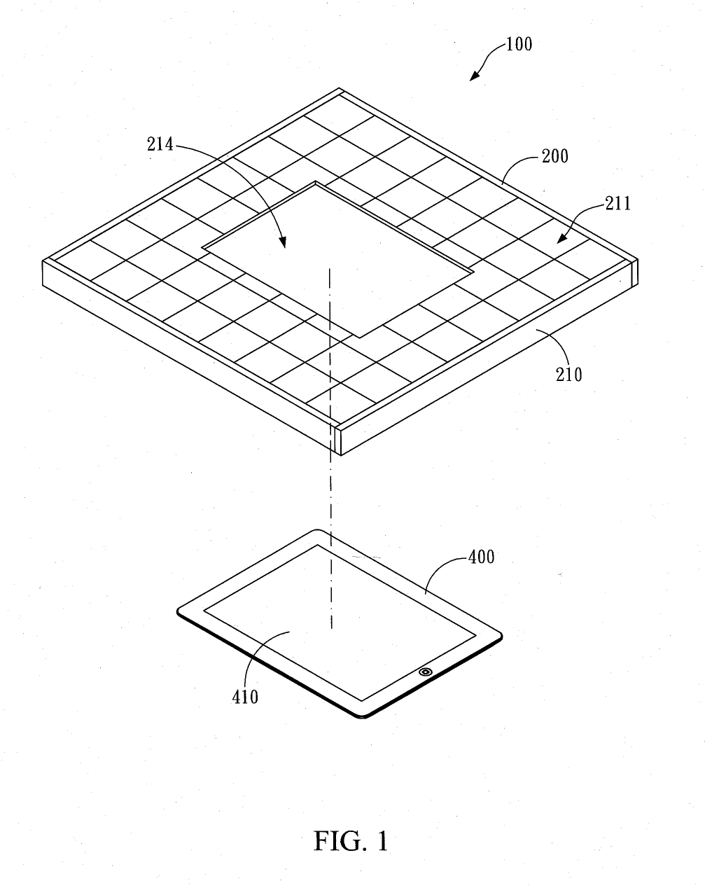

FIG. 1 is an exploded view of a gaming apparatus 100 of a first embodiment of the present invention.

Please refer to FIG. 1, in which the gaming apparatus 100 includes a board device 200 and an electric device 400 having a screen 410. The board device 200 is cooperated with the electric device 400 for using.

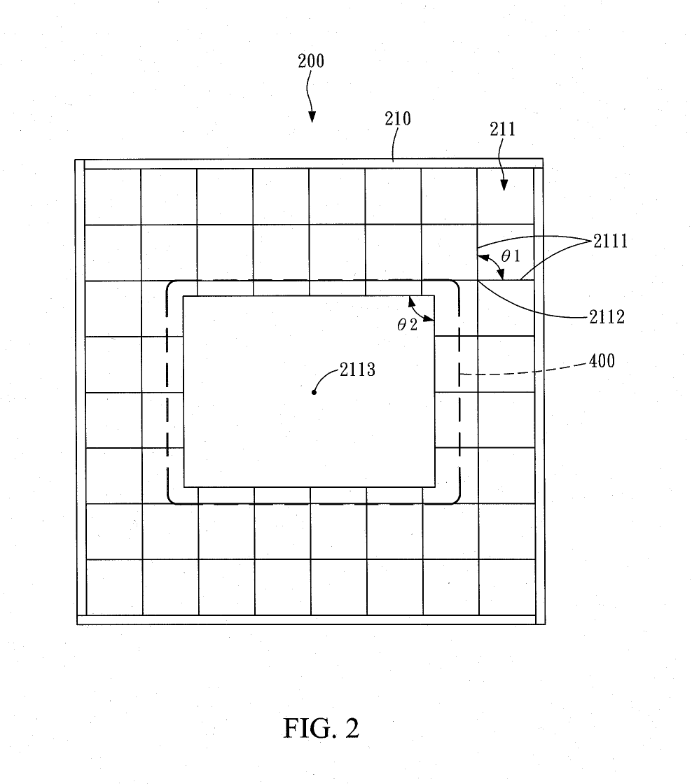

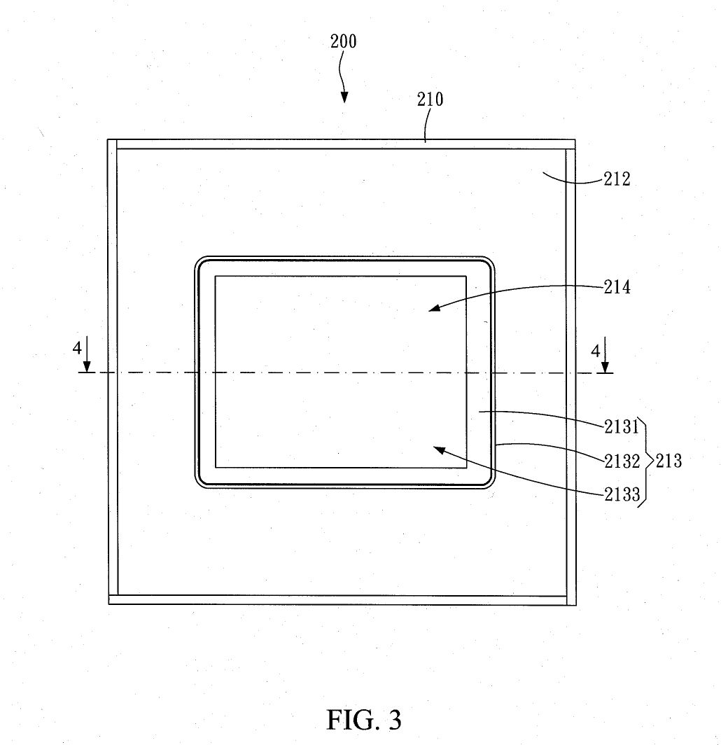

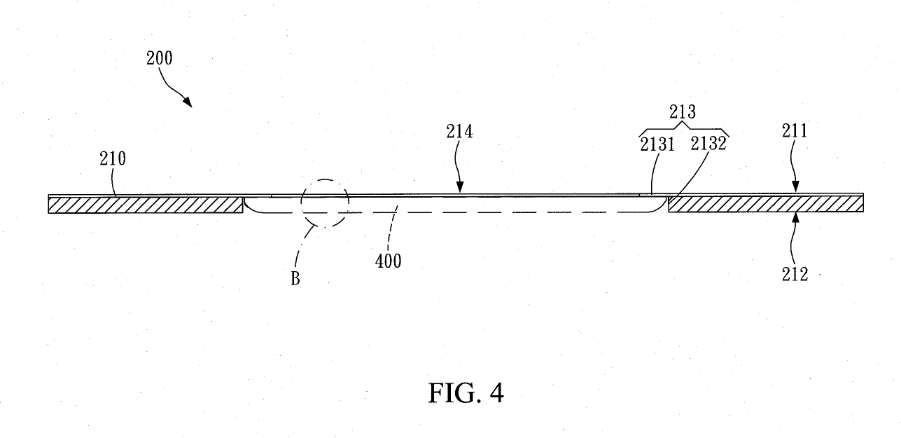

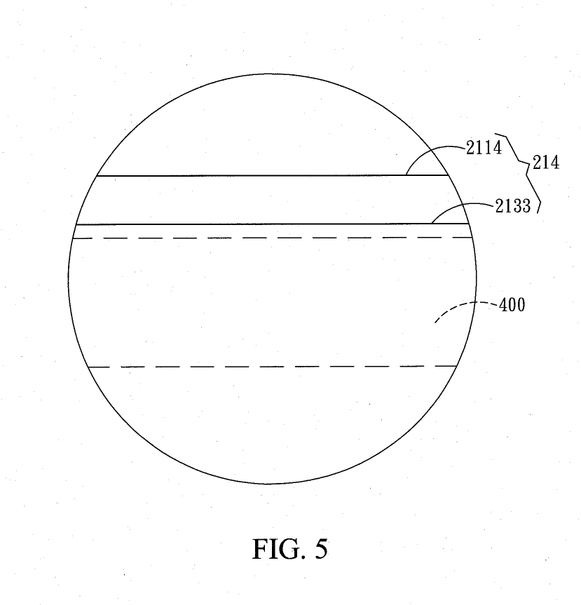

FIG. 2 is a top view of the board device 200 of the first embodiment of the present invention. FIG. 3 is a bottom view of the board device 200 of the first embodiment of the present invention. FIG. 4 is a cross-sectional view of FIG. 3 along line 3-3. FIG. 5 is an enlarged view of the B circle shown in FIG. 4.

Please refer to FIGS. 2-5, in which the board device 200 includes a board body 210. The board body 210 is formed as a plate and includes a board surface 211 and a bottom surface 212 which is opposite to the board surface 211. The bottom surface 212 is recessed inward so as to form a hollow 213. The board surface 211 has an upper opening 2114. A bottom portion 2131 of the hollow 213 has a lower opening 2133. The upper opening 2114 communicates with the lower opening 2133 so as to form a window 214, as shown in FIG. 5. The hollow 213 is arranged to receive the electric device 400, and at least one part of the screen 410 of the electric device 400 are revealed through the window 214.

In this embodiment, the shape and the size of the window 214 is the same as that of the screen of the electric device 400. Therefore, when the electric device 400 is received in the hollow 213 of the board device 200, the displayed region of the screen 410 can be revealed through the window 214, but embodiments of the present invention are not limited thereto. Further examples are described later.

Here, the electric device 400 is substantially a smart phone, a tablet computer, a media player or so forth. In the first embodiment, the electric device 400 is a tablet computer, for example.

As shown in FIG. 2, the board surface 211 includes a plurality of first lines 2111 crossed thereon. In this embodiment, the board surface 211 illustrates a chess board. Some first lines 2111 are parallel with each other and perpendicular with the other first lines 2111 correspondingly so as to form a plurality of arranged checks. Here, the chess board surface shown in FIG. 2 does not have the alternated black and white grid characters, but only shows and the frame lines of the chess board surface.

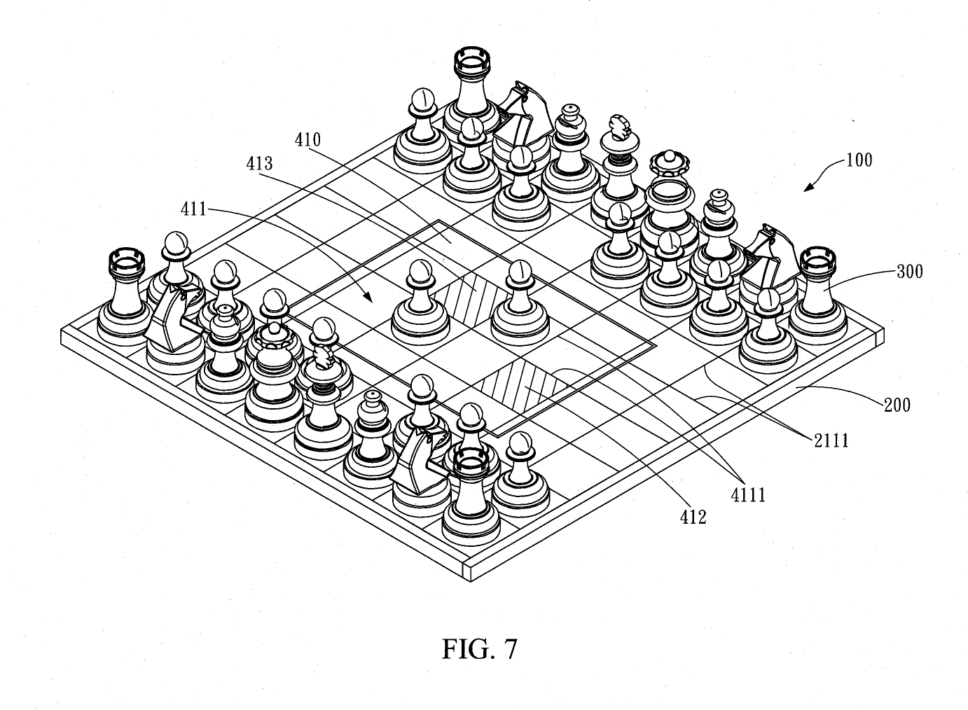

Here, the window 214 has a symmetrical geometrical shape; namely, the window 214 can be a symmetrical triangle, rectangle, hexagon, or other symmetrical polygons, circles or other regular polygons. However, embodiments of the present invention are not limited thereto. The window 214 can be arbitrary shaped except that the size of the window 214 is smaller than that of the hollow 213, as shown in FIG. 3. Therefore, as shown in FIG. 7, the screen 410 of the electric device 400 can display an electric board surface 411, so as to fill the blank part of the board surface 211 corresponding to the window 214.

In one embodiment, the window 214 covers a center region 2113 of the board surface 211, as shown in FIG. 2.

As shown in FIG. 2, the value of an included angle θ₁ in which the included angle θ₁ is formed between each two crossed first lines 2111 with a crossed point 2112 is the same as that of an interior angle θ₂ of the window 214 or the same as that of a supplementary angle of the interior angle θ₂. That is to say, the shape of the window 214 is depended on the arrangement of the first lines 2111. In this embodiment, one of each two crossed first lines 2111 is perpendicular arranged with another of each two crossed first lines 2111, so the window 214 is rectangle shaped.

In some embodiments, the shape of the window 214 is depended on the shape of the screen 410 of the electric device 400. As shown in FIG. 1, the shape of the screen 410 is rectangular, and the window 214 is rectangular, too. Here, besides the shape of the window 214, the size of the window 214 is also depended on the size of the screen 410 of the electric device 400. That is to say, the size of the window 214 can be the same as that of the screen 410 of the electric device 400. Based on this, the screen 410 of the electric device 400 displays the electric board surface 411, so as to fill the blank part of the board surface 211 corresponding to the window 214, as shown in FIG. 7

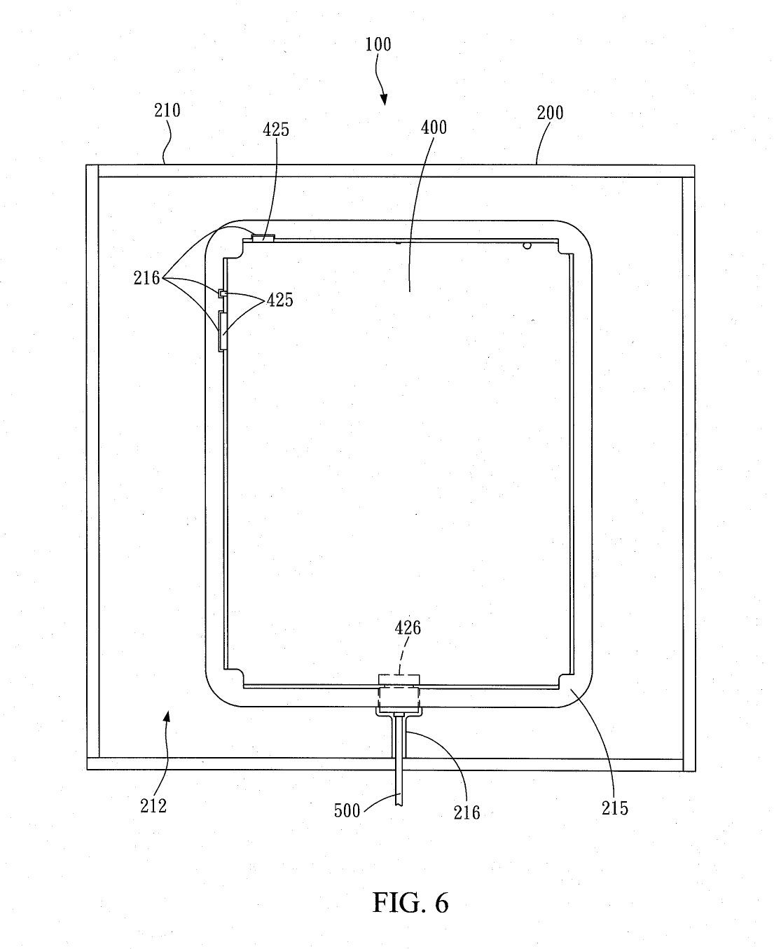

FIG. 6 is a top view of the gaming apparatus 100 of the first embodiment of the present invention.

Please refer to FIG. 3, FIG. 4 and FIG. 6, in which the side wall portion 2132 of the hollow 213 has a recessed portion 216 corresponding to the outline of the buttons 425 of the electric device 400. Based on this, the buttons 421 do not closely abut against the side wall portion 2132 of the hollow 213, so that the buttons 425 are not pressed unintentionally.

Similarly, the hollow 213 can have the recessed portion 216 corresponding to the outline of a connecting cable 500 (and the connector thereof). Here, the connecting cable 500 is used to insert into a connecting port 426 of the electric device 400. Based on this, when the electric device 400 is received in the hollow 213 of the board device 200, the electric device 400 still can be connected with an outer component via the connecting cable 500 (e.g., to charge the electric device 400 or to read data from the electric device 400). Here, the connecting cable 500 and the connecting port 426 meet the requirements of the communication protocols such as Universal Serial Bus (USB), Lighting and so forth or can be the power line and the power connecting port respectively for electricity transmission.

As shown in FIG. 6, in one embodiment, the board device 200 further includes a fastening structure 215 connected to the board body 210, so that the electric device 400 is fastened with the board device 200 via the fastening structure 215 when the electric device 400 is received in the hollow 213. Here, the fastening structure 215 is substantially a ring-shaped member corresponding to the shape of the window 214, so that after the electric device 400 is received in the hollow 213, the fastening structure 215 is closely abutted upon the window 214 so as to prevent the electric device 400 from detaching from the hollow 213, but embodiments of the present invention are not limited thereto. The fastening structure 215 can be a buckling structure disposed on the side wall portion 2132 of the hollow 213 so as to buckle with the electric device 400.

FIG. 7 is a perspective view of the gaming apparatus 100 of the first embodiment of the present invention.

As shown in FIG. 7, the screen 410 is capable of displaying the electric board surface 411, so that the electric board surface 411 and the board surface 211 form the complete board. Here, the electric board surface 411 has a plurality of second lines 4111 crossed thereon. The second lines 4111 are connected with the first lines 2111 of the board surface 211 in end to end relation and correspondingly.

Here, the gaming apparatus 100 further includes a plurality of board pieces 300 for placing on the screen 410 or on the board surface 211. The screen 410 is a touch screen for sensing the board pieces 300 placed thereon. The screen 410 can be embodied via different touch technologies so as to be a resistive touch screen, a capacitive touch screen, an electromagnetic touch screen, an optical touch screen or so forth. The structure of the board pieces 300 corresponds to the touch technology applied to the screen 410. For instance, when the screen 410 is a capacitive touch screen, the surfaces of the board pieces 300 are coated with electric conducting materials or the board pieces 300 are made of electric conducting materials.

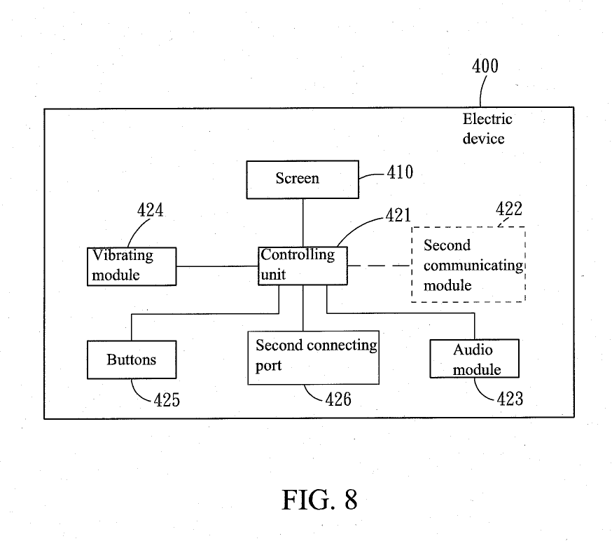

FIG. 8 is a schematic block view of the electric device 400 of the first embodiment of the present invention.

As shown in FIG. 8, besides the screen 410, the buttons 425 and the connecting port 426 mentioned above, the electric device 400 further includes a controlling unit 421, a communicating module 422, an audio module 423 and a vibrating module 424, but embodiments of the present invention are not limited thereto. The electric device 400 further includes a storage module for storing a computer program so as to show the electric board surface 411 after the controlling unit 421 loads the computer program. Here, the controlling unit 421 is substantially a central processing unit or an embedded controller. The audio module 423 includes audio output units, such as speaker and/or the audio connecting port. Furthermore, the audio module 423 further includes an audio input unit, like a microphone. The vibrating module 424 can be embodied as a vibrating motor.

Please refer to FIG. 7, in which the electric board surface 411 has a plurality of placing regions 412. Here, for the chessboard, the second lines 4111 are crossed so as to form the placing regions 412. At least one of the placing regions 412 is the event-trigger region 413. When the screen 410 senses that one of the board pieces 300 is placed on the event-trigger region 413, the interactive information is generated from the electric device 400. In other words, when the controlling unit 421 receives a first coordinate of the electric board surface 411 where the board piece 300 is placed on from the screen 410, the controlling unit 421 will further check if the first coordinate matches a second coordinate of the event-trigger region 413; if it does, the controlling unit 421 drives the audio module 423, the vibrating module 424 and/or the screen 410 to generate the interactive information. That is to say, the interactive information is presented as video, sound, vibration or combinations thereof. Here, the electric device 400 randomly defines the event-trigger region 413.

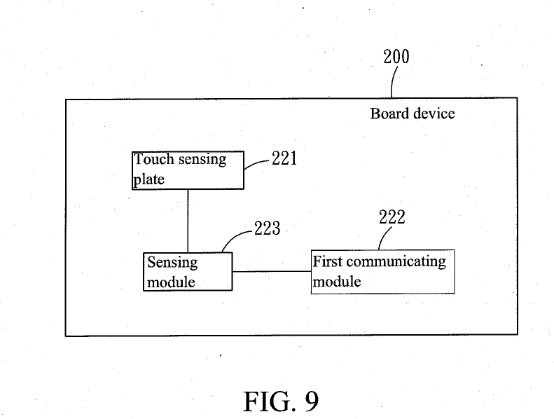

FIG. 9 is a schematic block view of the board device 200 of the first embodiment of the present invention.

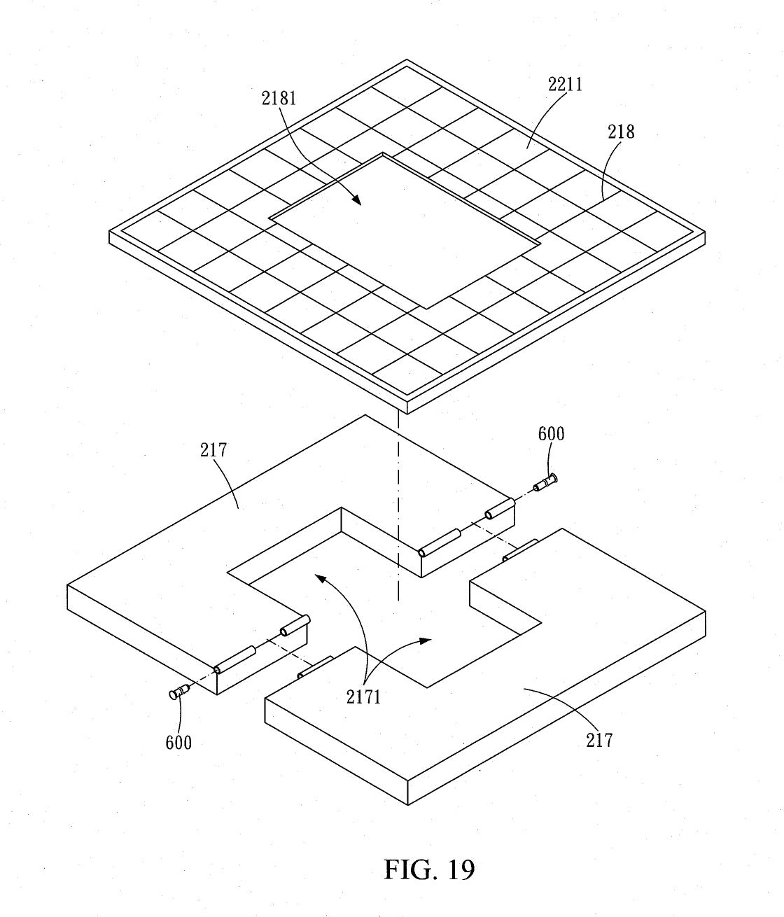

In one embodiment, the board device 200 is also capable of sensing the board pieces 300. As shown in FIG. 9, the board device 200 further includes a communicating module 222 and a sensing module 223. The board surface 211 is a touch sensing surface 2211, as shown in FIG. 19. The sensing module 223 senses the board piece 300 placed on a placing region of the board surface 2111 (for the chess board, the first lines 2111 are crossed so as to form the placing regions), and transmits the coordinate of the placing region to the electric device 400 by the communicating module 222. Therefore, the electric device 40 further checks if the coordinate of the placing region matches the coordinate of the event-trigger region 413; if it does, the interactive information mentioned above is generated.

Here, as shown in FIG. 8, the electric device 400 also includes the communicating module 422 so as to communicatively connect with the communicating module 222 of the board device 200. The communicative connection is accomplished so as to transmit messages via wire communication methods (such as USB, Ethernet), or wireless communication methods (such as Bluetooth, Wireless Fidelity (Wi-Fi)). If the communicative connection is accomplished via wire communication methods, the communicating module 422 can include communicating chips (such as an USB coding/decoding chip), and the connecting port 426 (such as an USB connecting port). If the communicative connection is accomplished via wireless communication methods, the communicating module 422 can include an antenna and a communicating circuit. The reason why the communicating module 422 shown in FIG. 8 is dash-lined is, in other embodiments, once the board device 200 does not have the ability of sensing the board pieces 300, the communicating module 422 will not be an essential element for the electric device 400. Meanwhile, the connecting port 426 can be applied to non-data transmissions, such as electricity transmission.

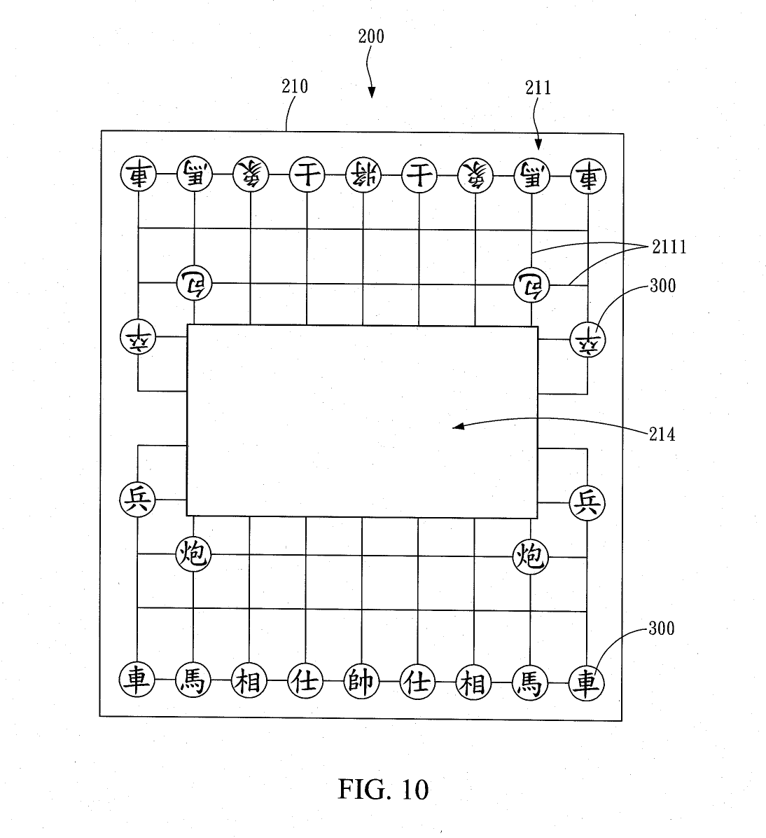

FIG. 10 is a top view of a board device 200 of a second embodiment of the present invention.

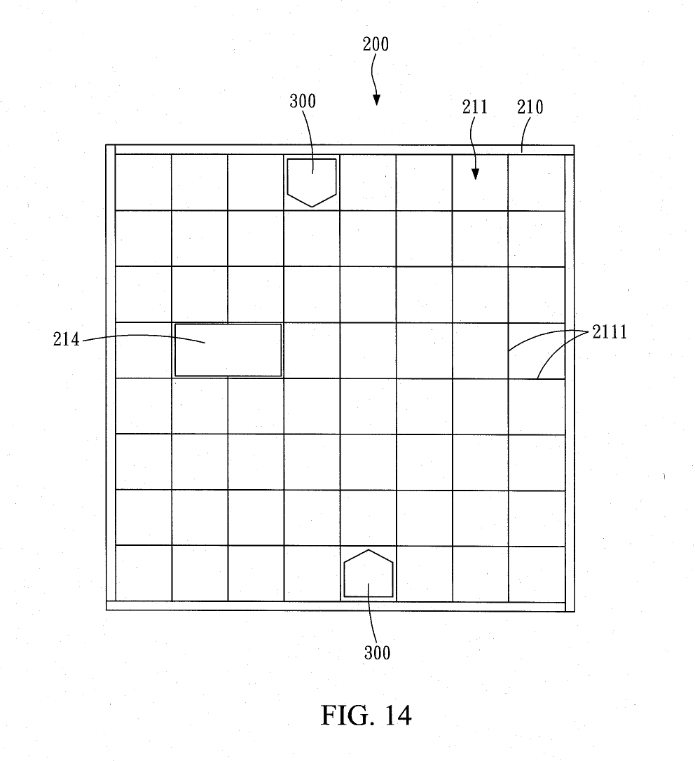

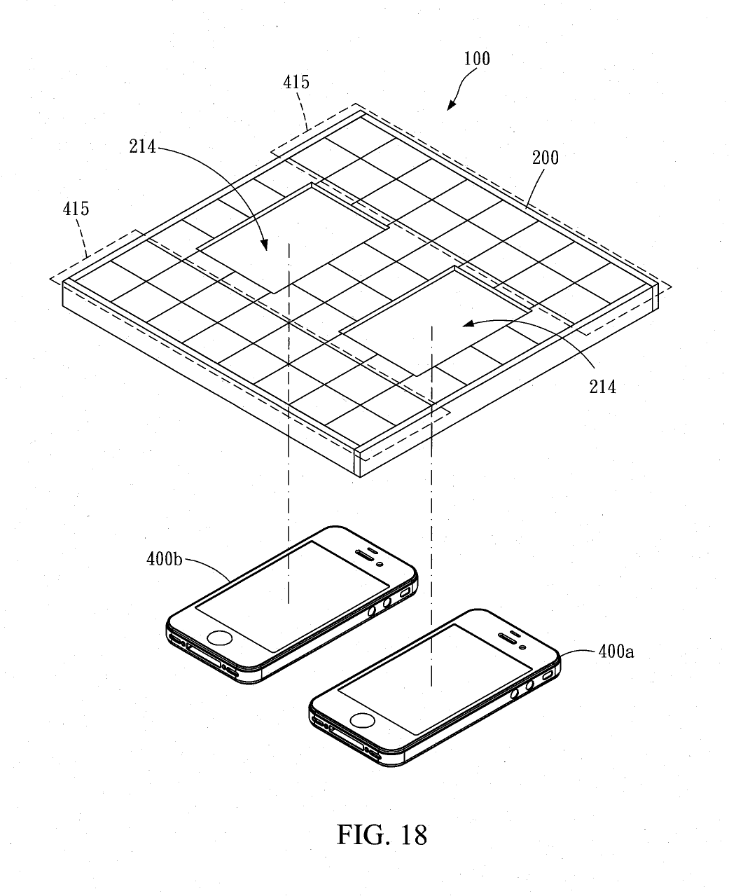

As shown in FIG. 10, in this embodiment, the board surface 211 illustrates a Chinese chess board. The window 214 is disposed on a center of the board surface 211, but embodiments of the present invention are not limited thereto. The window 214 is disposed near the edge of the board surface 211 in some embodiments, as shown in FIG. 14 and FIG. 18. That is to say, the window 214 can be disposed on everywhere of the board surface 211 except the initial placing regions 415 of the board pieces 300.

In one embodiment, as shown in FIG. 10, the board surface 211 has a first long axis (a longitudinal axis), and a first short axis (a transverse axis), which is perpendicular to the first long axis. The window 214 has a second long axis (a transverse axis), and a second short axis (a longitudinal axis), which is perpendicular to the second long axis. That is to say, the first long axis is parallel to the second short axis, and the second long axis is parallel to the first short axis.

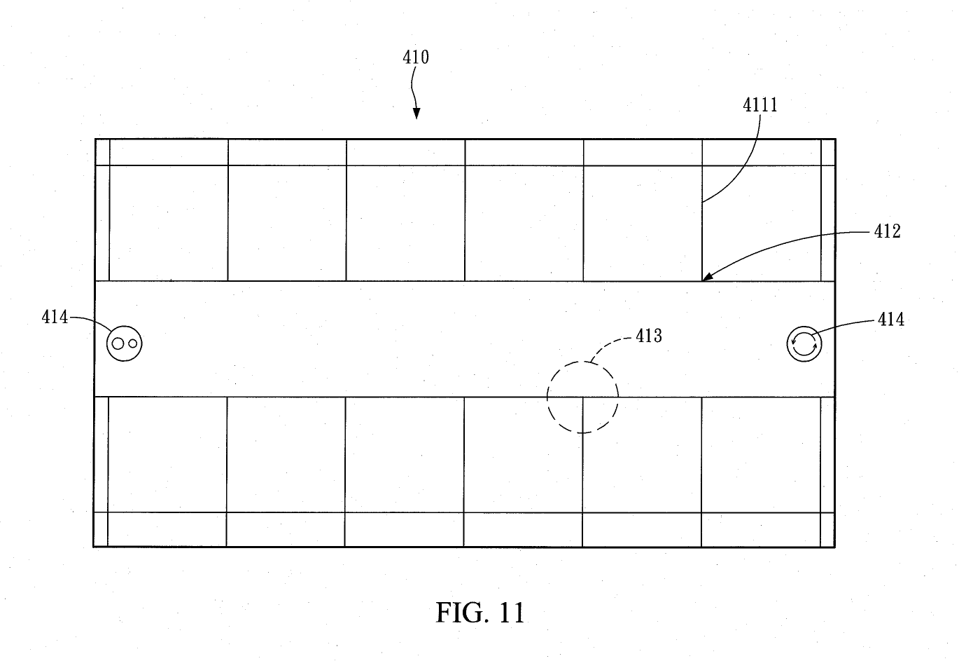

FIG. 11 is a schematic view for showing the electric board surface 411 of the second embodiment of the present invention.

Please refer to FIGS. 10-11, in which the electric board surface 411 in FIG. 11 can be completely revealed through the window 214 in FIG. 10. Additionally, the second lines 4111 of the electric board surface 411 can connect with the first lines 2111 of the board surface 211 in end-to-end relation so as to form a complete Chinese chess board plane. Based on the rules of the Chinese chess, the intersections of the second lines 4111 shown in FIG. 11 are the placing regions 412 of the board pieces 300. Therefore, the event-trigger region 413 can be the intersection formed by any two-second lines 4111. Here, the event-trigger region 413 can be an area; when parts of the bottom face of the board piece 300 are overlapped with the area, the controlling unit 421 is also capable of sensing that the board piece 300 is placed on the event-trigger region 413. The electric board surface 411 has an operating interface 414 (here, the operating interface 414 is an icon), which is a virtual button for the player to setup the computer program running on the electric device 400. For example, via the operating interface 414, the player can choose what kind of electric board surfaces 411 is shown, where the event-trigger region 413 is located, what the interactive information is displayed or so forth.

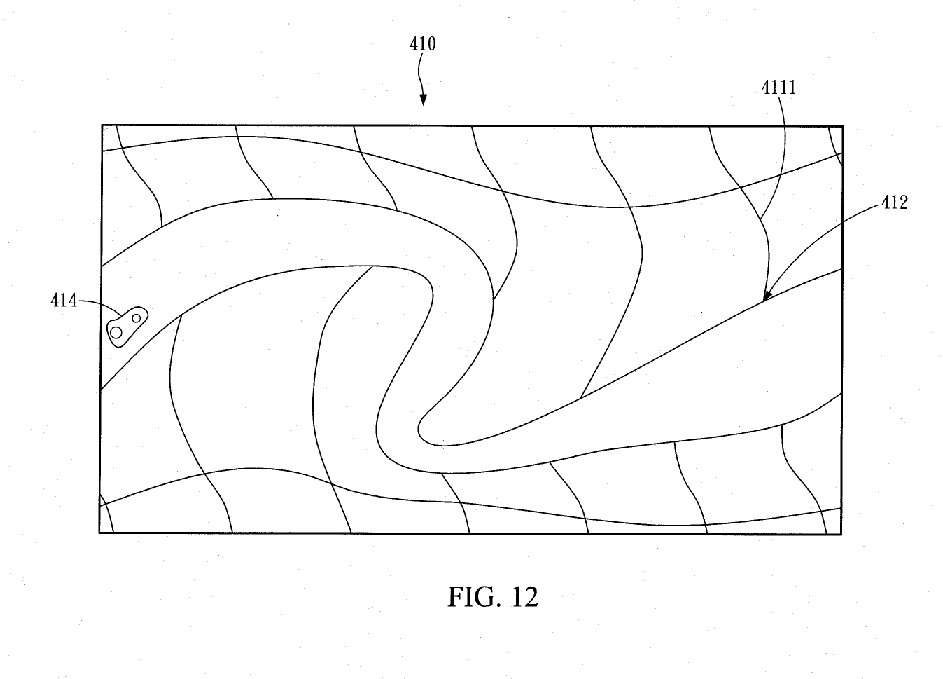

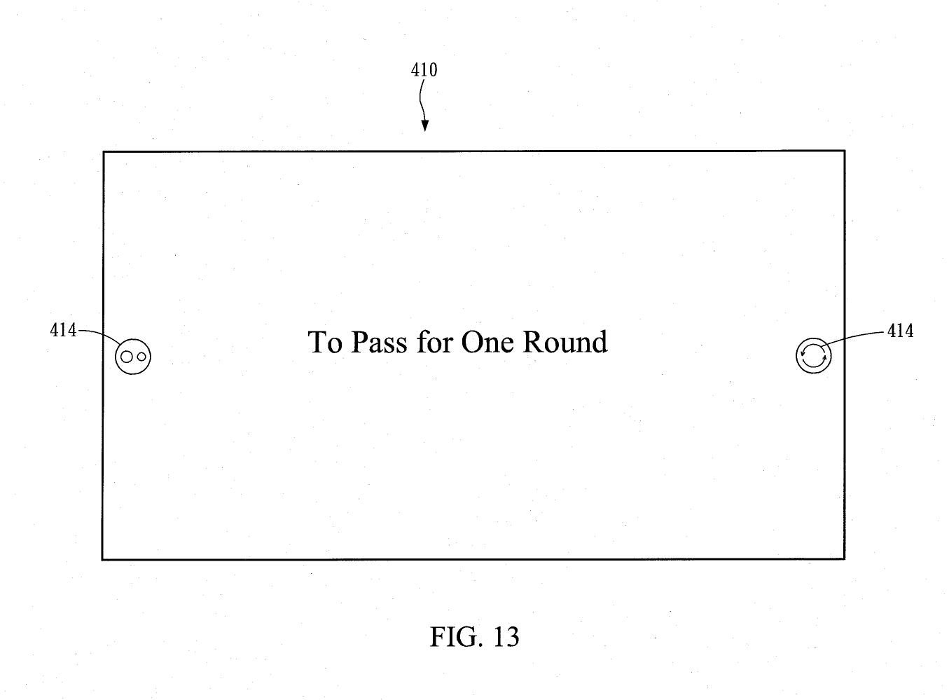

FIG. 12 is a schematic view for showing one interactive information of the second embodiment of the present invention. FIG. 13 is another schematic view for showing another interactive information of the second embodiment of the present invention.

When the event-trigger region 413 is triggered, an animation schematic view, as shown FIG. 12, is displayed on the screen 410, which is a twisted electric board surface 411. And then, the interactive information shown in FIG. 13 is displayed on the screen 410. As shown in FIG. 13, the interactive information displayed on the screen 410 is “To pause for one round”, which means the player who's board piece 300 is placed on the event-trigger region 413 must pause for one round. Based on this, the flexibility of board games can be improved, and the board games can be more interesting. Before the board game is started, via the operating interface 414, the players can set the interactive information shown on the screen 410 upon triggering the event-trigger region 413, such as to reborn the dead board piece 300, to exchange the board pieces 300 between players or so forth. Here, besides displaying in texts, the interactive information can also be displayed in figures, videos, animations or so forth; further, sound effects and/or vibrations can also be added to the interactive information.

FIG. 14 is a top view of a board device 200 of a third embodiment of the present invention.

As shown in FIG. 14, the board surface 211 illustrates a Japanese chess board. Therefore, the placing regions (or the placing regions 412) are the checks formed by crossing the first lines 2111 (or the second lines 4111). The window 214 reveals the screen 410 of the electric device 400. Here, the electric device 400 is a mobile phone.

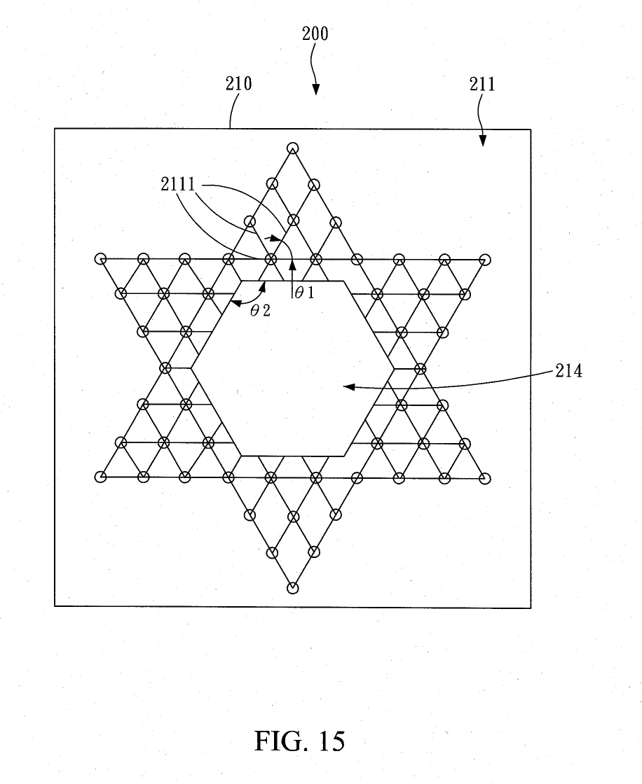

FIG. 15 is a top view of a board device 200 of a fourth embodiment of the present invention. As shown in FIG. 15, the board surface 200 illustrates a Chinese checkers board. The included angle θ₁ between the first lines 2111 of the board surface 211 is 60 degrees, and the interior angle θ₂ of the window 214 is 120 degrees. That is to say, the included angle θ₁ is the complementary angle of the interior angle θ₂ of the window 214. Here, if the electric device 400 with a rectangular screen 410 tends to reveal parts of the Chinese checkers hoard on the screen 410 through a hexagonal window 214, the window 214 will not cover parts of the screen 410.

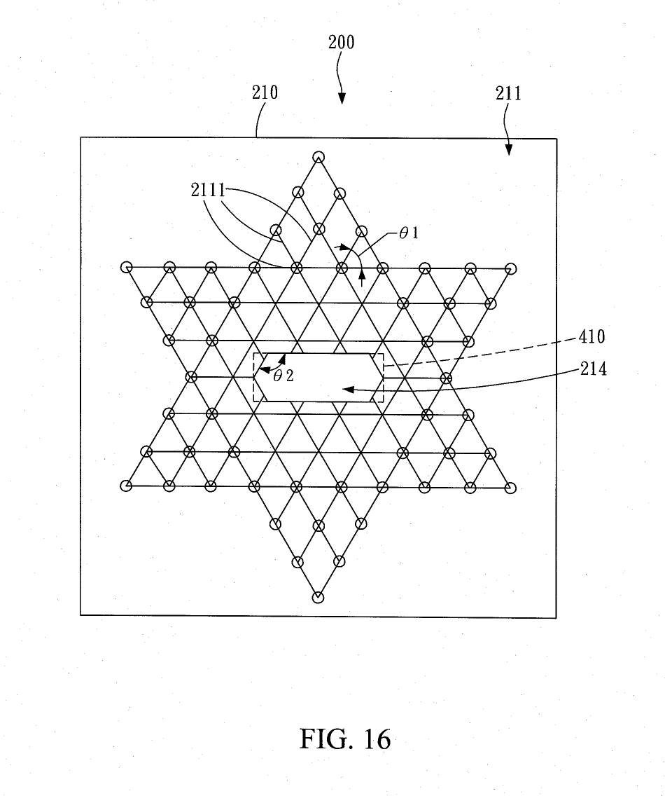

FIG. 16 is a top view of a board device 200 of a fifth embodiment of the present invention.

As shown in FIG. 16, the board surface 211 also illustrates the Chinese checkers board. Here, when the window 214 is not polygonal, the included angle θ₁ can also be the complementary angle of the interior angle θ₂ of the window 214. The displayed region of the screen 410 is partially revealed through the window 214.

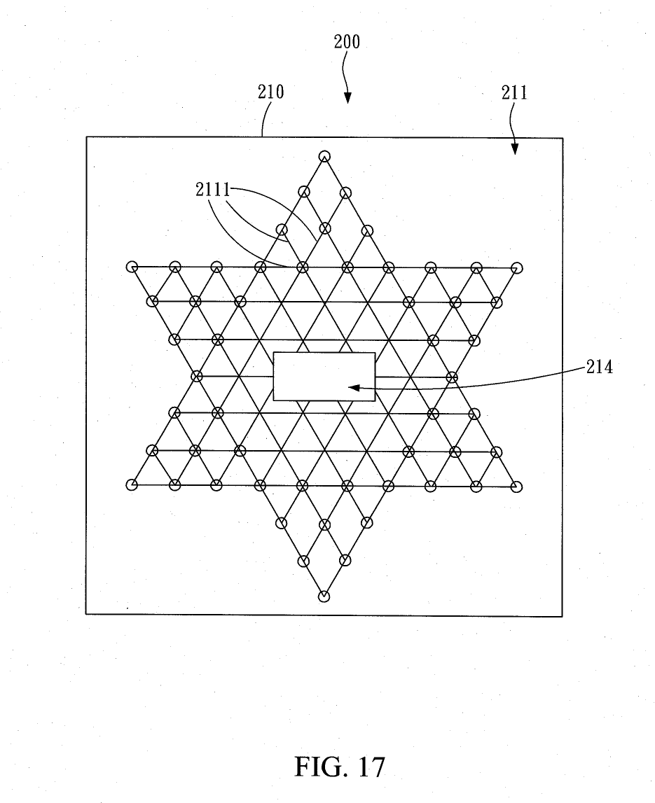

FIG. 17 is a top view of a board device 200 of a sixth embodiment of the present invention.

As shown in FIG. 17, the board surface 211 also illustrates the Chinese checkers board. Here, the window 214 is rectangle. That is to say, the shape of the window 214 does not have to depend on the arrangement of the first lines 2111 of the board surface 211.

FIG. 18 is a perspective view of a board device 200 of a seventh embodiment of the present invention.

As shown in FIG. 18, the board device 200 of the seventh embodiment has two windows 214. Here, the electric devices 400a, 400b are placed under the two windows 214 respectively so as to display two electric board surfaces 411 and form a complete board. The two players can set the event-trigger regions 413 through the operating interfaces 414 of the electric devices 400a, 400b. Since both the two players do not know the position of the event-trigger regions 413 set by the opponent player, the board game becomes interesting.

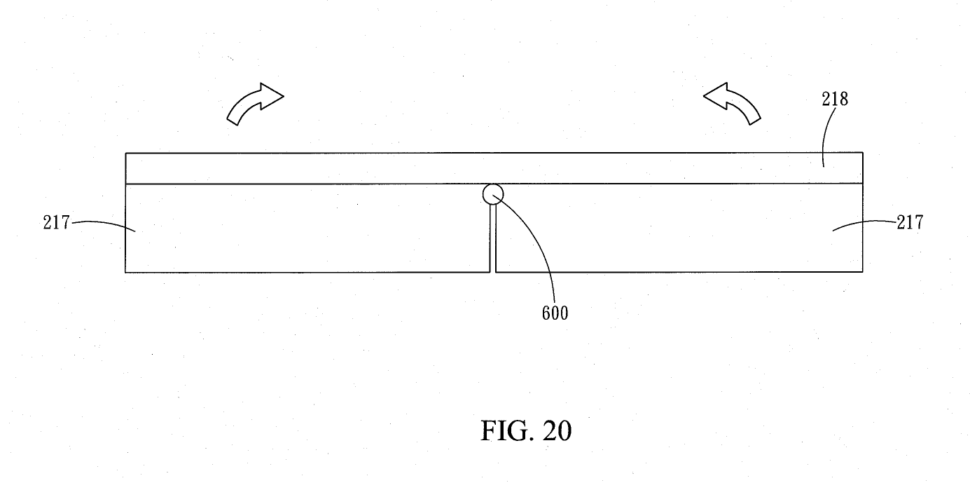

FIG. 19 is an exploded view of a board device 200 of an eighth embodiment of the present invention. FIG. 20 is a front view of the board device 200 of an eighth embodiment of the present invention.

As shown in FIG. 19, the board body 210 of the board device 200 is formed from two plates 217 and a covering 218 having a through hole 2181. Each plate 217 has a notch 2171. The two notches 2171 adjacent to each other and the covering 218 covered on the two plates 217 form the hollow 213 as mentioned above; meanwhile, the through hole 2181 forms the window 214 as mentioned above. The connection between the plates 217 and the covering 218 can be accomplished by adhering, locking, thermal melting or so forth.

In one embodiment, the two plates 217 are pivotally connected with each other via a pivoting shaft 600. Additionally, the covering 218 can be a bendable plate and made of paper, plastic, wood or other soft materials. Based on this, the plates 217 can be bent toward the board surface 211 so as to be folded for storing the board device 200 conveniently.

In one embodiment, as mentioned above, the board surface 211 is a touch sensing surface 2211. That is to say, the covering 218 can be a touch sensing plate 221 and coupled with the sensing module 223 mentioned above.

Based on the above, during playing, the board device 200 and the gaming apparatus 100 of the present invention can sense the placing regions 412 of the board pieces 300 on the electric board surface 411 displayed on the electric device 400 so as to trigger various random events, so that the board game can be more interesting.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A board device, cooperated with an electric device having a screen, comprising:
a board body, formed as a plate, having a board surface and a bottom surface which is opposite to the board surface, wherein the bottom surface is recessed so as to form a hollow, the board surface has an upper opening, a bottom portion of the hollow has a lower opening, the upper opening communicates with the lower opening so as to form a window, the hollow is configured to receive the electric device, and at least one part of the screen is revealed through the window.

2. The board device according to claim 1, wherein the window has a symmetrical geometrical shape.

3. The board device according to claim 1, wherein the board surface comprises a plurality of first lines crossed thereon, the value of an included angle formed between each two crossed first lines with a crossed point is the same as that of an interior angle of the window or the same as that of a supplementary angle of the interior angle.

4. The board device according to claim 1, wherein the size of the window is smaller than the size of the hollow.

5. The board device according to claim 1, further comprising a fastening structure connected to the board body, so that the electric device is fastened by the fastening structure when the electric device is received in the hollow.

6. The board device according to claim 1, wherein the hollow has a recessed portion corresponding to an outline of a button of the electric device.

7. The board device according to claim 1, wherein the hollow has a recessed portion corresponding to an outline of a connecting cable inserting into a connecting port of the electric device.

8. The board device according to claim 1, wherein the board body is formed from two plates and a covering having a through hole, each plate has a notch, the two notches adjacent to each other and the covering covered thereon form the hollow, and the through hole forms the window.

9. The board device according to claim 8, wherein the two plates are pivotally connected with each other.

10. The board device according to claim 8, further comprising a communicating module and a sensing module, wherein the covering is a touch sensing plate coupled with the sensing module, the sensing module senses a board piece placed on a placing region of the covering and transmits a coordinate of the placing region to the electric device by the communicating module.

11. A gaming apparatus, comprising:
an electric devices, having a screen; and
a board device, having a board body, the board body being formed as a plate and having a board surface and a bottom surface which is opposite to the board surface, the bottom surface being recessed so as to form a hollow, the board surface having an upper opening, the hollow having a lower opening, the upper opening communicating with the lower opening so as to form a window, the hollow being configured to receive the electric device, at least one part of the screen being revealed through the window.

12. The gaming apparatus according to claim 11, wherein the screen displays an electric board surface, the electric board surface and the board surface form a complete board.

13. The gaming apparatus according to claim 12, wherein the electric board surface has a plurality of second lines crossed thereon, the second lines are connected with the first lines of the board surface in end to end relation and correspondingly.

14. The gaming apparatus according to claim 11, wherein the board device has a first long axis and a first short axis perpendicular to the first long axis, the window has a second long axis and a second short axis perpendicular to the second long axis, and the first long axis is parallel to the second short axis.

15. The gaming apparatus according to claim 11, further comprising a plurality of board pieces configured to be placed on the screen or the board surface, wherein the screen is a touch screen for sensing the board pieces placed thereon.

16. The gaming apparatus according to claim 15, wherein the electric board surface has a plurality of placing regions, at least one of the placing regions is an event-trigger region, and an interactive information is generated from the electric device when the screen senses that one of the board pieces is placed on the event-trigger region.

17. The gaming apparatus according to claim 16, wherein the interactive information is presented as video, sound, vibration or combinations thereof.

18. The gaining apparatus according to claim 15, wherein the board device further has a communicating module and a sensing module, the board surface is a touch sensing surface, the sensing module senses one of the board pieces placed on a placing region of the covering and transmits a coordinate of the placing region to the electric device by the communicating module.

19. The gaming apparatus according to claim 18, wherein the electric device checks if the coordinate of the placing region matches the coordinate of the event-trigger region and, if it does, generates an interactive information.

20. The gaming apparatus according to claim 19, wherein the interactive information is presented as video, sound, vibration or combinations thereof.
